(19) United States
(12) Patent Application Publication
(10) Pub. No.: US 2013/0220760 A1
(43) Pub. Date: Aug. 29, 2013

(54) RATCHET BRAKING STRUCTURE

(71) Applicant: WOO SING INDUSTRIAL CO., LTD, (US)

(72) Inventor: Cheony-Sun TSAO, Taipei (TW)

(73) Assignee: WOO SING INDUSTRIAL CO., LTD, New Taipei City (TW)

(21) Appl. No.: 13/763,244

(22) Filed: Feb. 8, 2013

(30) Foreign Application Priority Data
Feb. 23, 2012 (TW) 101203298

(51) Int. Cl. F16D 15/00

(52) U.S. Cl. CPC F16D 15/00
USPC 192/45.1

(57) ABSTRACT

A ratchet braking structure, designed to solve the problem that a conventional braking pawl cannot resume its actuating position without a torsion spring, includes a ratchet wheel and a pair of pawls provided on two opposite sides of the ratchet wheel respectively. Each pawl has a center of rotation and two opposing end portions symmetrically provided with respect thereto, wherein the two end portions are an engaging end for engaging with and thereby locking the teeth of the ratchet wheel and a balancing end for enabling pawl position restoration. The engaging end of one pawl is diagonally opposite that of the other. The balancing end of each pawl extends from the side opposite the engaging end and can be pushed outward by the teeth of the ratchet wheel so that, even without additional position restoration means, the engaging end will stay where it can engage with the ratchet wheel.

### BACKGROUND OF THE INVENTION

1. Technical Field

This invention relates to a braking structure and, more particularly, to a stop structure employing a ratchet wheel-and-pawl assembly.

2. Description of Related Art

A ratchet, which is composed essentially of a ratchet wheel and a pawl, is configured for preventing backward rotation and thereby ensuring safety of operation. Ratchets are used in a variety of mechanical structures, some notable examples of which are hoists for lifting heavy objects and winders.

A manual hoist, for instance, is a load-lifting tool that has been around for quite a long time. Using a chain and a gear set to achieve power transmission, a manual hoist not only allows a heavy object to be hauled up manually but also provides mechanical advantage. In order to prevent the heavy object being lifted from falling, a manual hoist typically has a stop function realized by mutual restriction between a ratchet wheel and a pawl. FIG. 1 shows the ratchet wheel-and-pawl assembly in a conventional ratchet braking system. When a chain (not shown) is pulled downward to lift a heavy object (not shown), the ratchet wheel 91 is rotated clockwise. When the pulling of the chain stops and the heavy object begins to move downward due to gravity, the ratchet wheel 91 is rotated backward, i.e., counterclockwise. As soon as the ratchet wheel 91 starts backward rotation, the tip portion 93 of each of a pair of pawls 92, which are located on two sides of the ratchet wheel 91 respectively, is engaged in one of the tooth valleys 94 of the ratchet wheel 91 to stop the ratchet wheel 91 from rotating backward. This stopping effect ensures the operational safety of a manual hoist.

In the conventional stop or braking structure described above for use in a manual hoist, a pair of torsion springs 95 are respectively hooked to the pair of pawls 92 to keep the pawls 92 in actuating positions with respect to the ratchet wheel 91. The torsion springs 95 can force the pawls 92 back to their original positions after the pawls 92 are pushed outward by the ratchet wheel 91. Nonetheless, the torsion springs 95 tend to rust, break, get stuck, or undergo elastic fatigue when they have been used for a certain amount of time, and therefore fail to limit the positions of the pawls 92. Should that happen, the tip portions 93 of the pawls 92 will not be brought back to the ratchet wheel engaging positions after the pawls 92 are pushed outward by the ratchet wheel 91. As a result, the stop function of the manual hoist is lost, and the safety of the manual hoist, seriously compromised. The same problems can be found with electric hoists, winders, and like structures as well.

### BRIEF SUMMARY OF THE INVENTION

In view of the aforesaid drawbacks of the prior art, the present invention provides a ratchet braking structure configured for effectively solving the problem that the conventional pawls cannot resume their actuating positions without the assistance of torsion springs.

To achieve the foregoing object, the present invention proposes a ratchet braking structure including a ratchet wheel and a pair of pawls provided on two opposite sides of the ratchet wheel respectively. Each pawl has a center of rotation and a pair of opposing end portions symmetrically provided with respect to the center of rotation, wherein one end portion is an engaging end for engaging with and thereby locking the teeth of the ratchet wheel and the other end portion is a balancing end for restoring the position of the engaging end. Moreover, the engaging end of one of the pair of pawls is diagonally opposite the engaging end of the other pawl.

The foregoing ratchet braking structure is characterized in that each pawl has a balancing end extending from the side opposite the engaging end, and that the balancing end can be pushed outward by the teeth of the ratchet wheel, thereby keeping the engaging end in a position where it can contact and engage with the teeth of the ratchet wheel. Thus, torsion springs can be dispensed with, and the various problems resulting from torsion springs, eliminated.

In the foregoing ratchet braking structure, the tip portion of each engaging end preferably corresponds in shape to the tooth valley between each two adjacent teeth of the ratchet wheel.

In the foregoing ratchet braking structure, each balancing end preferably extends to a position where it can contact with the teeth of the ratchet wheel.

In the foregoing ratchet braking structure, the pawls are preferably located on a left side and a right side of the ratchet wheel respectively, and the line connecting the centers of rotation of the two pawls preferably coincides with a horizontal line passing through the center of the ratchet wheel.

While the pawls of the foregoing ratchet braking structure do not rely on torsion springs to remain where they can stop the ratchet wheel, the pawls in another preferred embodiment of the present invention are each connected with a torsion spring to provide even safer operation. To connect a torsion spring to each pawl, a hook portion of the torsion spring is hooked to a portion of the pawl that is adjacent to the engaging end so as to force the pawl back in position.

### BRIEF DESCRIPTION OF THE SEVERAL VIEWS OF THE DRAWINGS

The features of, and the preferred modes of carrying out, the present invention are now described with reference to at least one embodiment and the accompanying drawings, in which:

FIG. 1 schematically shows a conventional ratchet braking structure;

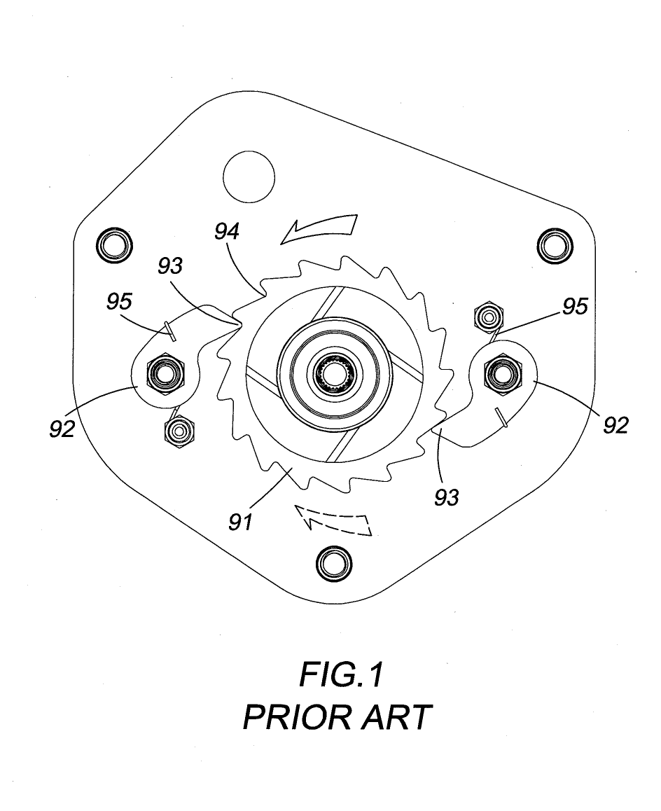

FIG. 2 schematically shows the ratchet braking structure in the first preferred embodiment of the present invention;

FIGS. 3A and 3B schematically show operation of the ratchet braking structure in the first preferred embodiment of the present invention, with FIG. 3A showing clockwise rotation of the ratchet wheel and FIG. 3B, counterclockwise rotation of the ratchet wheel; and

FIG. 4 schematically shows the ratchet braking structure in the second preferred embodiment of the present invention.

### DETAILED DESCRIPTION OF THE INVENTION

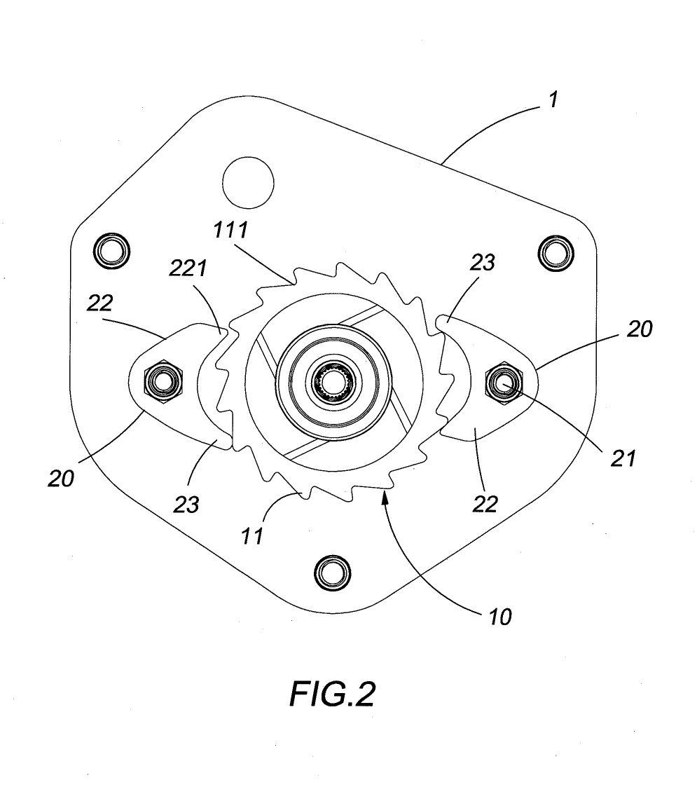

As shown in FIG. 2, the ratchet braking structure 1 in the first preferred embodiment of the present invention includes a ratchet wheel 10 and a pair of pawls 20 located on a left side and a right side of the ratchet wheel 10 respectively. The ratchet wheel 10 is identical to known ratchet wheels, whereas the pawls 20 are characterized by the following: each pawl 20 has a center of rotation 21 and a pair of opposing end portions symmetrically provided with respect to the center of rotation 21, wherein one end portion is formed as an engaging end 22 and the other end portion, as a balancing end 23. Each engaging end 22 has a tip portion 221 corresponding in shape to the tooth valley 111 between each two adjacent teeth 11 of the ratchet wheel 10. Each balancing end 23, on the other hand, is more slender than each engaging end 22 and extends to a position where it can contact with the teeth 11 of the ratchet wheel 10. The two pawls 20 are arranged in such a way that the engaging end 22 of one pawl 20 is diagonally opposite the engaging end 22 of the other pawl 20. As shown in FIG. 2, the engaging end 22 of the right pawl 20 is located at a lower position while the engaging end 22 of the left pawl 20 is located at an upper position. Similarly, the balancing end 23 of one of the two pawls 20 is diagonally opposite the balancing end 23 of the other pawl 20.

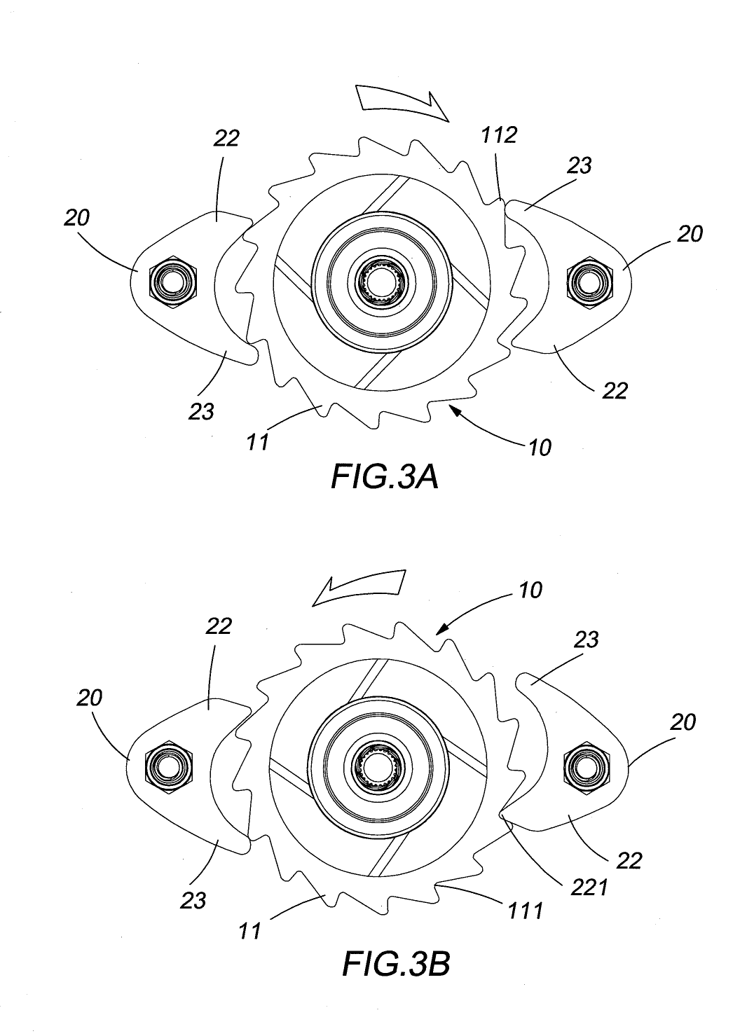

Reference is now made to FIGS. 3A and 3B, in which the ratchet braking structure in the first preferred embodiment is applied to a manual hoist. When the manual hoist is in the process of lifting a heavy object, a chain (not shown) is pulled downward, thereby driving the ratchet wheel 10 to rotate clockwise (see FIG. 3A). In the meantime, at least one of the engaging ends 22 or at least one of the balancing ends 23 of the pawls 20 respectively provided on two sides of the ratchet wheel 10 remains in contact with the tooth tips 112 of the teeth 11 of the ratchet wheel 10. When the lifting operation is stopped and the chain is no longer pulled, the ratchet wheel 10 is subjected to the gravitational inertia of the heavy object and hence rotated backward, i.e., counterclockwise (see FIG. 3B). The moment the ratchet wheel 10 begins rotating backward, the engaging end 22 of one of the pawls 22 is readily brought into engagement with the nearest tooth valley 111 of the ratchet wheel 10, thus limiting further backward rotation of the ratchet wheel 10. Consequently, the heavy object being lifted is kept from falling indefinitely, and the safety of the lifting operation is ensured.

As stated above, in the course in which the ratchet wheel 10 is rotated clockwise (see FIG. 3A), at least one of the engaging ends 22 or at least one of the balancing ends 23 of the pawls 20 is in contact with the tooth tips 112 of the ratchet wheel 10. Therefore, when an engaging end 22 is pushed outward by a tooth tip 112 due to clockwise rotation of the ratchet wheel 20, a leverage effect takes place such that the balancing end 23 of the same pawl 20 is tilted slightly toward the ratchet wheel 10. Soon after that, the very balancing end 23 is pushed outward by the upcoming tooth tip 112. Thus, like the two ends of a lever, the engaging end 22 and the balancing end 23 of each pawl 20 move in a mutually dependent and balancing manner when respectively and successively pushed outward by the tooth tips 112. This allows the pawls 20 to be in constant contact with the ratchet wheel 10 in the absence of torsion springs or other additional devices. The balancing end 23 of each pawl 20 serves as the torsion spring of a conventional pawl and can force the engaging end 22 of the same pawl 20 to move back to the position where the engaging end 22 can interact with the ratchet wheel 10.

Once the ratchet wheel 10 is rotated backward, i.e., counterclockwise (see FIG. 3B), the engaging end 22 of one of the pawls 20 is driven deep into a tooth valley 111 of the ratchet wheel 10 by the ratchet wheel 10 in backward rotation and is engaged in the tooth valley 111. As a result, a leverage effect occurs, and the balancing end 23 of the same pawl 20 swings outward and is brought out of contact with the ratchet wheel 10. However, as soon as the ratchet wheel 10 is rotated clockwise, this balancing end 23 resumes contact with the ratchet wheel 10.

The ratchet braking structure in the first preferred embodiment is innovative in that each pawl 20 has not only an engaging end 22 but also a balancing end 23 extending from the side opposite the engaging end 22. The balancing end 23 of each pawl 20 can be pushed outward by the teeth 11 of the ratchet wheel 10 so that, without having to resort to additional means, the engaging end 22 of the same pawl 20 will stay in a position where it can engage with the ratchet wheel 10.

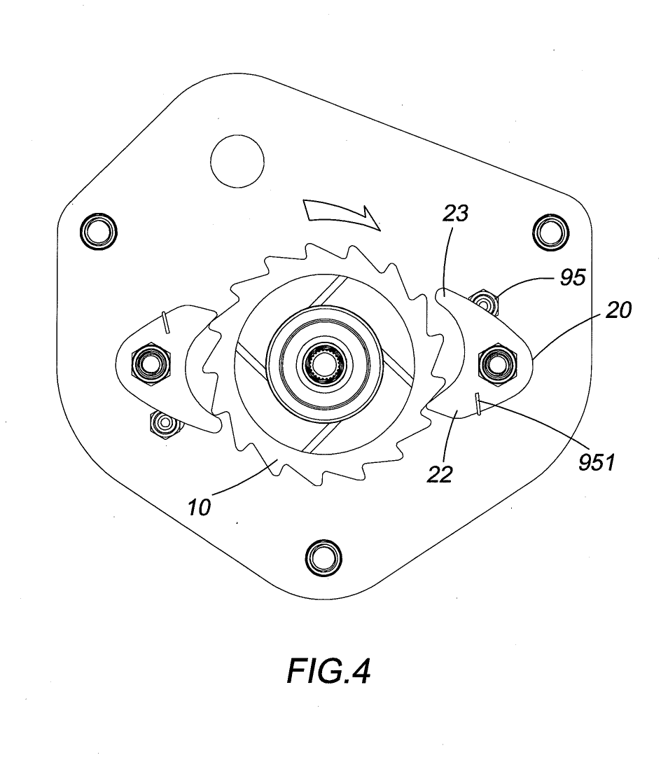

While the ratchet braking structure in the first preferred embodiment of the present invention can achieve pawl position restoration with the help of the balancing ends 23 and without such forcing devices as torsion springs, it is also feasible for each pawl 20 in the first preferred embodiment to be provided with a forced position restoration device such as a torsion spring. Referring to FIG. 4 for the ratchet braking structure in the second preferred embodiment of the present invention, the pawls 20 are each connected with a conventional torsion spring 95. For example, the hook portion 951 of each torsion spring 95 is hooked to the corresponding pawl 20 in this preferred embodiment at a position adjacent to the engaging end 22, so as for the torsion springs 95 to assist in pawl position restoration. The joint use of the torsion springs 95 and the pawls 20 does not require modification of related structures or compromise position restoration of the engaging ends 22 as enabled in the first preferred embodiment by the balancing ends 23 alone.

In each of the first and the second preferred embodiments described above, the pawls 20 of the ratchet braking structure are provided adjacent to the two ends of a horizontal diameter of the ratchet wheel 10 respectively. More specifically, the centers of rotation 21 of the two pawls 20 and the center of the ratchet wheel 10 are on the same horizontal line.

However, as different types of tools or machines have different operation requirements, the center-to-center line of the two pawls 20 may also form an included angle with the horizontal line passing through the center of the ratchet wheel 10; that is to say, the line connecting the centers of rotation 21 of the two pawls 20 does not necessarily coincide with the horizontal line passing through the center of the ratchet wheel 10. In addition, although the centers of rotation 21 of the two pawls 20 in each of the first and the second preferred embodiments form an included angle of 180 degrees with respect to the center of the ratchet wheel 10, this included angle may be any angle less than 180 degree.

The embodiments described above are intended only to demonstrate the preferred modes of carrying out the present invention but not to limit the scope of the present invention. A person of ordinary skill in the art who has read the foregoing technical description may change or modify the disclosed embodiments without departing from the technical spirit of the present invention. The scope of the present invention is defined by the appended claims.

What is claimed is:

1. A ratchet braking structure, comprising a ratchet wheel and a pair of pawls provided on two opposite sides of the ratchet wheel respectively, the ratchet braking structure being characterized in that:
each said pawl has a center of rotation and a pair of opposing end portions symmetrically provided with respect to the center of rotation, wherein one of the end portions is an engaging end for engaging with and thereby locking teeth of the ratchet wheel and the other end portion is a balancing portion for restoring a position of the engaging end; and
the engaging end of one of the pawls is diagonally opposite the engaging end of the other pawl.

2. A ratchet braking structure according to claim 1, wherein each said engaging end has a tip portion corresponding in shape to a tooth valley between each two adjacent said teeth of the ratchet wheel.

3. A ratchet braking structure according to claim 1, wherein each said balancing end extends in such a way as to contact with the teeth of the ratchet wheel.

4. A ratchet braking structure according to claim 1, wherein the pawls are provided on a left side and a right side of the ratchet wheel respectively.

5. A ratchet braking structure according to claim 4, wherein a line connecting the centers of rotation of the two pawls coincides with a horizontal line passing through the center of the ratchet wheel.

6. A ratchet braking structure according to claim 1, further comprising a pair of torsion springs connected to the pair of pawls respectively.

7. A ratchet braking structure according to claim 6, wherein each said torsion spring has a hook portion hooked to a portion of a corresponding said pawl that is adjacent to the engaging end of the pawl.
